(19) United States
(12) Patent Application Publication
(10) Pub. No.: US 2010/0198848 A1
(43) Pub. Date: Aug. 5, 2010

(54) INTELLIGENT LABEL FOR COSMETIC PRODUCT

(75) Inventors: Nils Hoffman, Hamburg (DE); Soren Jaspers, Schenefeld (DE)

Correspondence Address: SEED INTELLECTUAL PROPERTY LAW GROUP PLLC, 701 FIFTH AVE, SUITE 5400, SEATTLE, WA, 98104, US

(73) Assignee: BEIERSDORF AG, Hamburg (DE)

(21) Appl. No.: 12/525,536

(22) PCT Filed: Jan. 29, 2008
(86) PCT No.: PCT/EP2008/051003

§ 371 Date: Mar. 23, 2010

(30) Foreign Application Priority Data
Feb. 3, 2007 (DE) 102007005542.2

(51) Int. Cl. G06F 17/30; H04Q 5/22

(52) U.S. Cl. 707/758; 340/10.1; 707/E17.014

(57) ABSTRACT

The invention relates to a method for determining a cosmetic product suitable for a user. In order to facilitate for the user the determination and selection of a cosmetic product suitable for him/her, the method has a step of storing first data in a memory element, the first data representing a cosmetic profile of the user, a storing of second data in an intelligent label, the second data representing a cosmetic profile of the cosmetic product, and the intelligent label being assigned to the cosmetic product, a step of transmitting the second data from the intelligent label to the memory element, a step of a comparison of the first data and the second data, and a step of determining the cosmetic product as a cosmetic product suitable for the user if the first data and the second data at least partially coincide with one another.

The invention relates to a method and a system for determining a cosmetic product suitable for a user, wherein the system has a memory element and an intelligent label. The invention further relates to a cosmetic product with at least one intelligent label.

The cosmetics industry offers its customers or users of its cosmetic products a large number of cosmetic products. Cosmetic products are, for example, products for facial care, hair care and styling, body care, sun care, hand care, deodorants, body cleaning and decorative cosmetics such as, for example, products for the face, eyes, lips and nails. Within these product categories, special products adapted to the different needs and properties of the body and preference of the user are frequently available to the user for selection. Thus, for example, within the product category “facial care” there are particular products for younger skin or more mature skin. For example, in the product category “hair care” there is a product group for shampoo and a product group for conditioners which have a special suitability for different properties of the hair, for example for colored hair, for blonde hair, for dry hair and the like. In the product category “decorative cosmetics” there is, for example, a product group for decorative eye cosmetics, comprising special products such as mascara, eye shadow and kohl, which are in turn offered to the user in different colors and embodiments, such as, for example, water-resistant and water-soluble mascara.

It is difficult for the customer to find the “correct” product because of the large number of products. The selection of a cosmetic product suitable for the user may take place both amongst cosmetic products to be acquired and also amongst those which have already been acquired. Because of the great wealth of different product categories, product groups and special cosmetic products adapted to special properties and needs of the user, selection is frequently not easy and clear. Too much is frequently asked of customers or users of the cosmetic products, therefore, in the selection of cosmetic products suitable for them or they require a great deal of time to select the cosmetic products which are suitable for them from the wealth of products offered.

Problems also arise in selecting a suitable cosmetic product from the fact that the product descriptions, which are frequently in small print, are difficult to read, in particular for older people.

DE 200 12 273 U1 relates to a handheld computer for purchasing planning and completion. According to this, a conventional handheld computer is designed to allow the user to plan, organize and complete his purchases. A handheld computer of this type replaces a conventional shopping list, in other words it provides the user with information as to whether products are to be obtained, are just being obtained or have already been obtained.

EP 1 505 538 A2 discloses an intelligent label (“smart label”) provided to attach to goods, with an electronic circuit, a memory for receiving product-specific data, in particular, and a device for data transmission. Product-specific data are references, for example serial numbers or “EAN” codes, which may be supplemented by simple plain text data, such as the production date, product designation or producer's name. The smart label is assigned a sensor means and the label is activated as a result of an effective excitation of the sensor means for data exchange, the response of the sensor means taking place by means of a targeted action on the label, it being possible for the physical nature of the action to be any action, for example a finger pressure.

The object of the present invention is to facilitate for the user the determination and selection of a cosmetic product suitable for him/her.

The object is achieved according to the invention by a method as claimed in claim 1. The method according to the invention stores first data in a memory element. The first data represent a cosmetic profile of the user. The method according to the invention comprises the step of a storing of second data in an intelligent label, the second data representing a cosmetic profile of the cosmetic product and the intelligent label being assigned to the cosmetic product. The method further comprises the step of transmitting the second data from the intelligent label to the memory element and the step of comparing the first data and the second data. According to the invention, the cosmetic product is determined as a cosmetic product suitable for the user if the first data and the second data at least partially coincide with one another.

The cosmetic profile of the user reflects the properties of the body of the user and the needs of the user with regard to cosmetic products which are suitable for him/her. Within this profile, properties about the type of hair and/or type of skin of the user are stored, for example. Details of this type may, for example, define whether the user has a particularly dry, a younger, a more mature, or a sensitive or similar specified skin.

The cosmetic profile of the cosmetic product defines the suitability and the area of application of the cosmetic product. Thus, it is stored in the cosmetic profile of the cosmetic product whether this is, for example, a cream for dry, younger, more mature, for particularly sensitive or similar specified skin. Chemical, biological and/or physical data are stored in the cosmetic profile of the cosmetic product. Thus, the cosmetic profile may provide information about what degree of moisture the cosmetic product had (“moisture control”), when it was opened (“period after opening”, PAO), what durability date it has (“maintenance due date”, MDD), how much of the content of the cosmetic product has already been used (“filling level”) etc. The cosmetic profile of the cosmetic product is represented by the second data, which are stored in the intelligent label (“smart label” or else “intelligent label”).

According to the invention, using the intelligent label and the memory element, for example, a cosmetic product, the cosmetic profile of which defines a suitability for dry skin, is determined as suitable for a user if it is stored in the cosmetic profile of the user that the user has a dry skin. A cosmetic product, the durability date of which has expired can also be determined as no longer suitable for the user.

In a preferred embodiment, the method furthermore has a step of determining the cosmetic profile of the user on the basis of at least one property of the body, in particular the hair and/or skin, of the user and/or at least one detail, which characterises a cosmetic product which is suitable for the user and/or particularly preferred by the user. One property of the body of the user is, for example, the nature of the hair and/or the skin. The user may, for example, have colored, dry hair etc. Furthermore, the cosmetic profile may be determined by a detail, which defines decorative cosmetics particularly suitable for the user or preferred by him/her. The user may also give certain properties, such as, for example, scent, consistency etc. of certain products as preferred. For example, it is defined in such details whether black mascara particularly suits the user or is preferred by him/her. Likewise, it may be defined in the detail whether a user, for example, prefers a particular eye shadow shade or type in conjunction with a special mascara product, lip product etc.

In a further preferred embodiment, the intelligent label is a transponder, in particular an RFID transponder. A transponder is a wireless communication, display or control unit, which receives incoming signals and automatically responds thereto. Such transponders may be active or passive, depending on whether they take the energy required for communication and for processing internal processes exclusively from the field of the read/write unit, in other words work without their own energy supply, or, as active systems, have their own energy supply, for example in the form of a battery. Semi-active transponders as a mixed form are also possible. According to the invention, an RFID system is preferably used to store the cosmetic profile of the cosmetic product and to allow a communication of these data to a receiving unit, i.e. the memory element according to the invention. The RFID system comprises a transponder as an intelligent label and a reader unit, which is arranged in the memory element according to the invention. The RFID transponder stores the second data, which can be read without contact and without visual contact by the reader unit in the memory element.

The memory element preferably has a reader unit, in particular an RFID reader unit for the intelligent label. The intelligent label and the memory element form a transceiver system in this preferred embodiment.

In a particularly preferred embodiment, the method further has the step of determining the cosmetic profile of the cosmetic product on the basis of at least a suitability of the cosmetic product for a property of the body, in particular the hair and/or the skin, of the user and/or at least one detail, in particular color and type, which characterises a decorative cosmetic. The suitability of the cosmetic product may, for example, be determined for dry hair and/or skin and the like. The detail may contain information about what the color and type of the decorative cosmetic is, in other words, for example, the colors, black, brown or blue, of a water-resistant or water-soluble mascara.

In a further advantageous embodiment, the intelligent label is arranged on the cosmetic product, and/or on a product shelf, which in particular has the cosmetic product. If the intelligent label is arranged directly on the cosmetic product, it is possible for the user to directly establish using the system of the memory element and cosmetic product, whether this specific product is suitable for him/her for a cosmetic use. If the intelligent label is arranged on a product shelf, the user can establish whether the cosmetic product, which is preferably arranged on this product shelf, meets his/her cosmetic needs. In this arrangement, outlay is advantageously saved for the attachment of the intelligent label to each individual product as a single intelligent label on a product shelf can be assigned to all the products on this product shelf.

Advantageously, the intelligent label transmits the second data to the memory element in response to a request signal of the memory element. In this embodiment, the memory element, which is preferably brought into the vicinity of the intelligent label by the user, scans the second data of the intelligent label. If a passive transponder, in particular RFID transponder, is used as the intelligent label, the transponder obtains the energy to transmit the second data to the memory element from the radio field of the memory element. If the transponder receives a signal through the reader unit, it sends its stored data as a response to this request signal to the memory element.

In a further preferred embodiment, the method further comprises the step of displaying information as to whether the cosmetic product is determined as a suitable cosmetic product for the user and/or which of the first and the second data at least partially coincided with one another. In this preferred embodiment, the user preferably receives optical information which informs him/her of the result of the comparison of the first and second data. In this manner, the user directly receives the information as to whether the cosmetic profile of the cosmetic product at least partially coincides with his/her own cosmetic profile and is suitable for him/her. On the basis of this information it can be decided whether he/she selects the cosmetic product.

The invention further relates to a system as claimed in claim 9 for determining a cosmetic product which is suitable for a user and has a memory element according to the invention and an intelligent label according to the invention. Furthermore, the invention relates to a memory element as claimed in claim 10 and an intelligent label as claimed in claim 11. The invention further relates to a cosmetic product as claimed in claim 12, which has at least one intelligent label according to the present invention.

The invention will be described below with the aid of an embodiment and with the aid of the following figures, in which:

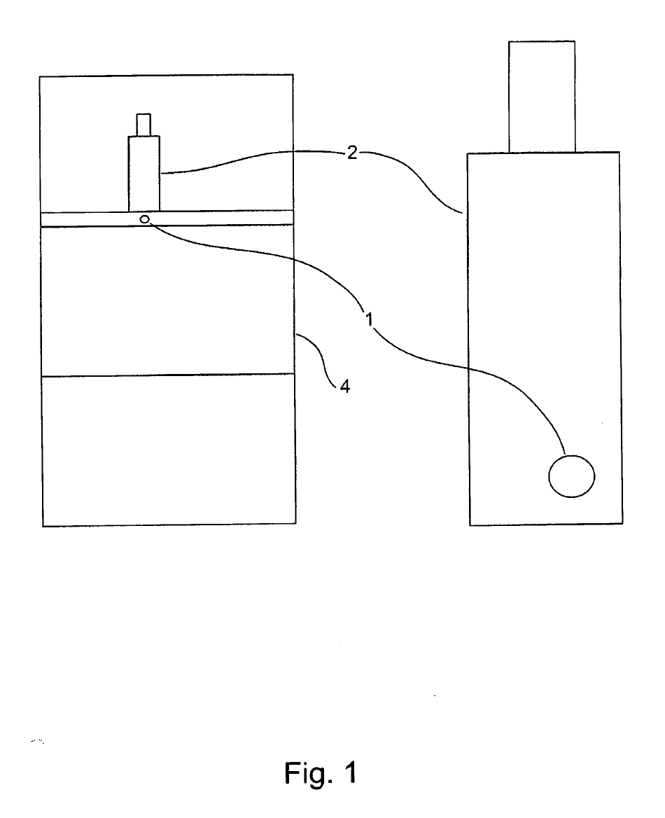

FIG. 1 shows schematic views of the use of the intelligent label according to the invention,

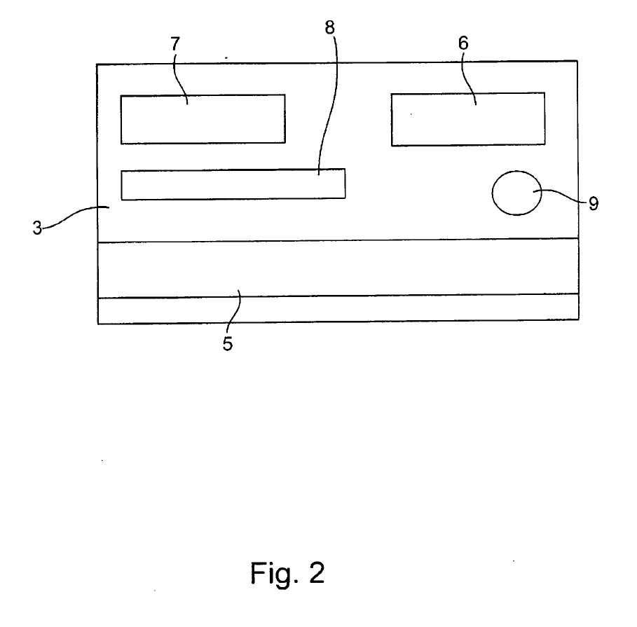

FIG. 2 shows a schematic view of the memory element according to the invention, and

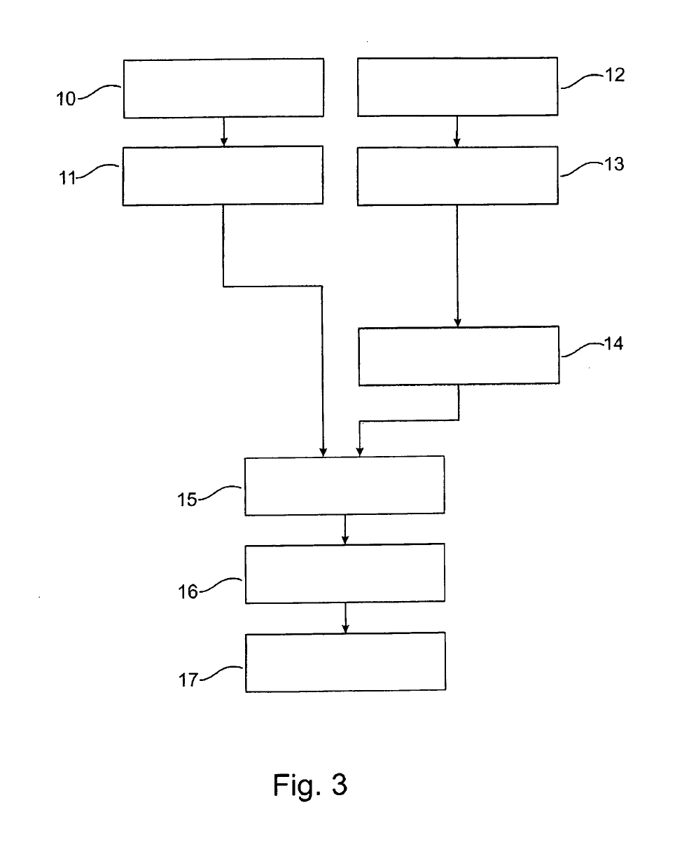

FIG. 3 shows a schematic flowchart of the method according to the invention.

FIG. 1 shows two different embodiments of the use of the intelligent label 1 according to the invention.

In a first embodiment, the intelligent label 1 is attached to a product shelf 4 to identify the cosmetic products 2 which are arranged on the product shelf 4 and to provide the second data of the cosmetic profile of the cosmetic product 2.

In a second embodiment, the intelligent label 1 is directly arranged on the cosmetic product 2. According to these two embodiments, the intelligent label 1 is a passive RFID transponder, which provides information such as, for example, “the cosmetic product 2 is a shampoo for normal hair”, “the cosmetic product 2 is a rich cream for dry skin”, “the cosmetic product 2 is a bright red lipstick” and the like.

FIG. 2 shows a schematic view of a memory element 3 according to the present invention. The memory element 3 shown in FIG. 3 is a chip card. In other embodiments, a clock, telephone or another device may have the memory element 3 according to the invention. Stored in a data area 5 of the memory element 3 are the first data, which represent the cosmetic profile of the user. The cosmetic profile defines, for example, the fact that the user, to whom the memory element 3 is assigned, has dry skin and normal hair and black mascara suits him/her particularly well. The name or another identification feature of the user is noted in an identification area 7.

The reader unit 9 of the memory element 3 sends a request signal to the intelligent label 1 as soon as it is, for example, brought into the close vicinity of the intelligent label 1. Other forms of activation of the communication between the memory element 3 and the intelligent label 1 are also possible. The reader unit 9, in response to this request signal, receives the second data of the intelligent label 1.

The area 8 of the memory element 3 is configured to compare the first and second data with each other and to determine whether the cosmetic product 2 can be defined as a suitable product 2 for the user of the memory element 3. Furthermore, an energy supply element, such as, for example, a solar field is arranged in the area 8 and supplies both the memory element 3 and the intelligent label 1 with energy. Finally, it is indicated to the user in the display area 6 of the memory element 3 whether the cosmetic product 2 is suitable for him/her, in other words, the result of the comparison and determination according to the method of the invention is notified to the user. This takes place, for example, by means of optical signals in the form of a green light if the cosmetic product 2 coincides with the cosmetic profile of the user, and with a red light, if the profiles did not agree.

FIG. 3 schematically shows an embodiment of the method according to the invention. The cosmetic profile of the user is determined in step 10. This may take place, for example, by means of a measurement device, which measures data of the body of the user, or by means of filling out a questionnaire, in particular an electronic questionnaire on the internet. In step 11, the first data, which represent the cosmetic profile of the user, are stored on the memory element 3. In step 12, the cosmetic profile of the cosmetic product 2 is determined. In step 13, the second data, which represent the cosmetic profile of the cosmetic product 2, are stored in the intelligent label 1. The steps 10, 11, 12, 13 can be carried out in any time sequence; in other words, it is not fixed whether the first data are determined and/or stored before the second data or vice versa.

In step 14, the communication between the intelligent label 1 and memory element 3 is activated in that the user guides the memory element 3, for example the chip card, past the cosmetic product 2. The intelligent label 1 receives a request signal of the memory element 3, in particular the reader unit 9, as a result, and thereupon transmits the second data to the reader unit 9 of the memory element 3. In step 15, the first and second data are compared with one another and matched, in other words, the properties and details of the cosmetic profile of the user are compared with the suitabilities and details of the cosmetic product 2. In step 16, the result of this comparison is evaluated in order to determine whether the cosmetic product 2 is suitable for use by the user. In step 17, a product recommendation is displayed to the user with the aid of the comparison result. If the cosmetic product 2 is suitable for use by the user, the user is free to select this product. If the cosmetic product 2 should not be suitable for use by the user, the steps of the method according to the invention, in particular steps 14 to 17, can be repeated in that the user brings the memory element 3 into the vicinity of another cosmetic product 2, to compare his/her cosmetic profile with the cosmetic profile of the other cosmetic product 2 and possibly obtain another result of the process of comparison and determination.

1. A method for determining a cosmetic product (2) suitable for a user, comprising the steps:
storing first data in a memory element (3), the first data representing a cosmetic profile of the user,
storing second data in an intelligent label (1), wherein the second data represent a cosmetic profile of the cosmetic product (2) and wherein the intelligent label (1) is assigned to the cosmetic product (2),
transmitting the second data from the intelligent label (1) to the memory element (3),
comparing the first data and the second data, and
determining the cosmetic product (2) as a cosmetic product (2) suitable for the user when the first data and the second data at least partially coincide with one another.

2. The method as claimed in claim 1, wherein the method also has the following step:
determining the cosmetic profile of the user on the basis of at least one property of the body, in particular the hair and/or the skin, of the user and/or at least one detail which characterises a cosmetic product which is suitable for the user and/or particularly preferred by the user.

3. The method as claimed in claim 1 or 2, wherein the intelligent label (1) is a transponder, in particular an RFID transponder.

4. The method as claimed in at least any one of the preceding claims, wherein the memory element (3) has a reader unit (9), in particular an RFID reader unit (9), for the intelligent label (1).

5. The method as claimed in at least any one of the preceding claims, wherein the method further comprises the following step:
determining the cosmetic profile of the cosmetic product (2) on the basis of at least a suitability of the cosmetic product (2) for a property of the body, in particular the hair and/or the skin, of the user and/or at least one detail, in particular color and type, which characterises a decorative cosmetic.

6. The method as claimed in at least any one of the preceding claims, wherein the intelligent label (1) is arranged on the cosmetic product (2) and/or on a product shelf (4), which, in particular, has the cosmetic product (2).

7. The method as claimed in at least any one of the preceding claims, wherein the intelligent label (1) transmits the second data to the memory element (3) in response to a request signal of the memory element (3). 20

8. The method as claimed in at least any one of the preceding claims, wherein the method further comprises the following step:
displaying information as to whether the cosmetic product (2) is determined as a cosmetic product (2) suitable for the user and/or which of the first data and the second data at least partially coincide with one another.

9. A system for determining a cosmetic product (2) suitable for a user, comprising:
a memory element (3) for storing first data, wherein the first data represent a cosmetic profile of the user, and
an intelligent label (1) for storing second data, wherein the second data represent a cosmetic profile of the cosmetic product (2) and wherein the intelligent label (1) is assigned to the cosmetic product (2),
wherein the intelligent label (1) is configured to transmit the second data to the memory element (3), and
wherein the memory element (3) is configured to compare the first data and the second data, and to determine the cosmetic product (2) as a cosmetic product (2) suitable for the user if the first data and the second data at least partially coincide with one another.

10. A memory element (3) for storing first data, wherein the first data represent a cosmetic profile of a user, wherein the memory element (3) is configured,
to receive second data from an intelligent label (1), wherein the second data represent a cosmetic profile of a cosmetic product (2) and wherein the intelligent label (1) is assigned to the cosmetic product (2),
to compare the first data and the second data, and
to determine the cosmetic product (2) as a cosmetic product (2) suitable for the user if the first data and the second data at least partially coincide with one another.

11. An intelligent label (1) for storing second data, wherein the second data represent a cosmetic profile of a cosmetic product (2) and wherein the intelligent label (1) is assigned to the cosmetic product (2), wherein the intelligent label (1) is configured,
to transmit the second data to a memory element (3), wherein the memory element (3) is configured to determine the cosmetic product (2) as a cosmetic product (2) suitable for a user if the first data and the second data at least partially coincide with one another, wherein the first data represent a cosmetic profile of the user.

12. A cosmetic product (2) with at least one intelligent label (1) as claimed in claim 11.
